(19) United States
(12) Patent Application Publication
(10) Pub. No.: US 2026/0057460 A1
(43) Pub. Date: Feb. 26, 2026

(54) ARTIFICIAL INTELLIGENCE BASED SYSTEM AND METHOD FOR GENERATING AND PURCHASING MATERIALS LISTS FOR CONSTRUCTION AND REPAIR JOBS

(71) Applicant: Derek Dixon, Wildomar, CA (US)

(72) Inventors: Derek Dixon, Wildomar, CA (US); David Kendal, El Cajon, CA (US); Brandon Carlson, Chicago, IL (US)

(21) Appl. No.: 19/288,164

(22) Filed: Aug. 1, 2025

Related U.S. Application Data
(60) Provisional application No. 63/686,353, filed on Aug. 23, 2024.
(60) Provisional application No. 63/760,736, filed on Feb. 20, 2025.

(51) Int. Cl. G06Q 50/08; G06Q 10/0631; G06Q 30/0601

(52) U.S. Cl. CPC G06Q 50/08; G06Q 10/063118; G06Q 10/06313; G06Q 30/0631; G06Q 30/0633; G06Q 30/0605; G06Q 30/0641

(57) ABSTRACT

The invention relates to an application that utilizes artificial intelligence to enhance project management in construction and repair industries. The system includes a user computing device, an application server, and a database server. The application server processes project data, including blueprints, to generate materials lists, integrates with online marketplaces to facilitate purchasing, and employs machine learning for product recommendations. The system also uses predictive analytics to forecast project deliveries and prevent backorders, while optimizing resource allocation through efficient supplier and material selection. The software application features an AI-powered chat, job planner, marketplace, and cart, providing a comprehensive platform for real-time collaboration among contractors, suppliers, and manufacturers. This innovation streamlines project workflows, reduces errors, and improves overall efficiency in managing construction and repair projects.

### CROSS-REFERENCE TO RELATED PATENT DOCUMENTS

This application claims the benefit of and priority to U.S. Provisional Patent Application No. 63/686,353 filed on 23 Aug. 2024, and U.S. Provisional Patent Application No. 63/760,736 filed on 20 Feb. 2025, the entire contents of each of which are incorporated herein by reference in their entirety.

### FIELD OF THE INVENTION

The present invention relates to software systems and methods, particularly to those used in the construction and repair industries. More specifically, the present invention discloses a software application that integrates the generation of materials lists with purchasing capabilities, streamlining the process of acquiring necessary materials for construction or repair tasks.

### BACKGROUND

In the construction and repair industries, managing materials effectively is crucial for the success of any project. Traditionally, professionals have relied on manual methods or disparate tools to plan their tasks, generate materials lists, and purchase the required items. These processes are often time-consuming, error-prone, and inefficient. One common issue is the lack of integration between the different stages of a construction or repair job. For instance, after creating a materials list based on project requirements, users typically need to manually search for and purchase these materials from various suppliers. This involves visiting multiple websites or physical stores, comparing prices, checking availability, and making purchases. The fragmentation of these steps leads to inefficiencies and increased chances of mistakes, such as ordering incorrect quantities, missing items, or overpaying for materials. Moreover, the manual nature of these processes can be particularly challenging for those without extensive related experience. Additionally, even experienced professionals can face challenges when managing large or complex projects. Therefore, there is a need for a more efficient and integrated solution that can streamline these processes. By automating the generation of materials lists and integrating the purchasing process within the same platform, the efficiency and accuracy of managing construction and repair projects can be greatly improved. Such a solution would not only save time and reduce errors but also make it easier for users to complete their projects successfully. The present invention addresses these challenges by providing a system and method that seamlessly integrates materials list generation with purchasing capabilities, all within a single software application. This innovation simplifies the entire process, enabling users to quickly and easily obtain the materials they need for their construction or repair projects, thus overcoming the inefficiencies and difficulties associated with traditional methods.

### BRIEF SUMMARY

The present invention discloses an intelligent building application that utilizes advanced artificial intelligence (AI) to transform the management of construction and repair projects. The software application is designed to empower contractors and project managers by providing a comprehensive tool that integrates project bidding, resource allocation, and construction assistance within a single platform. By leveraging AI, the application can analyze product data and read blueprints, enabling users to generate precise materials lists and accurate job takeoffs. This capability significantly reduces bid times, cuts costs, and minimizes errors that could lead to overrun charges. In an embodiment, the software application is structured around four key functions, accessible through dedicated tabs within the software application. The first tab, an AI-powered chat, assists the users by helping them locate materials, tools, and relevant product data. The second tab, a job planner, allows the users to organize jobs, manage contractors, schedule tasks, and upload plans for takeoff, which can be tracked within the marketplace. The marketplace tab serves as a centralized hub where the users can connect with suppliers, ensuring that the materials identified in the job planner are readily available for purchase. The final tab, the cart, tracks all materials selected from various vendors, enabling the users to monitor product usage across different jobs. Furthermore, the software application incorporates machine learning algorithms to provide intelligent product recommendations based on user queries or blueprint data. It also utilizes predictive analytics to anticipate project deliveries and manage scheduling and backorders effectively. Through resource optimization, the system ensures efficient allocation of materials and supplies, meeting specific project requirements. The application serves as a collaborative platform, facilitating communication and coordination among developers, contractors, suppliers, and manufacturers, thus enhancing the overall efficiency and effectiveness of project management in the construction industry.

In an aspect, the present invention discloses a system for managing construction and repair projects utilizing artificial intelligence. The system comprises an application server configured to host a software application incorporating an artificial intelligence platform. The system further comprises a user computing device configured to execute the software application and transmit project-related data to the application server. The application server is configured to analyze the project-related data to generate a list of required materials and associated product information. The software application is further configured to enable procurement of one or more of the materials from one or more online marketplaces based on the generated list, such that the system facilitates intelligent material planning and purchasing from within a unified application environment.

In an embodiment, the artificial intelligence platform is trained on construction-specific language, blueprint interpretation, and product specification data. In an embodiment, the project-related data includes user-entered inputs, uploaded blueprints, schedules, and construction requirements. In an embodiment, the artificial intelligence platform analyzes one or more blueprints to identify materials required for the project. In an embodiment, the application server is configured to recommend one or more products based on availability, compatibility with project specifications, and compliance with applicable construction standards. In an embodiment, the application server is further configured to generate step-by-step task instructions based on the project-related data. In an embodiment, the user computing device includes a mobile application providing a user interface with tabs for chat, job planning, marketplace browsing, and material tracking. In an embodiment, the software application includes an AI-powered chat interface configured to receive user queries and respond with project guidance or product suggestions. In an embodiment, the software application includes a marketplace interface that displays real-time data from multiple suppliers or online marketplaces. In an embodiment, the application server retrieves supplier data including product availability, pricing, delivery times, and certifications. In an embodiment, the system allocates products to specific jobs or job phases based on the user's project plan. In an embodiment, the system includes a cart interface that enables users to track selected materials by supplier, quantity, cost, and delivery schedule. In an embodiment, the artificial intelligence platform uses predictive analytics to forecast delivery delays, supplier shortages, or material backorders. In an embodiment, the system is configured to cross-reference product data against one or more compliance standards, including ISO, ASTM, or local regulatory codes. In an embodiment, the application server dynamically updates material recommendations based on modifications to the project-related data. In an embodiment, the user computing device is configured to allow uploading of job plans or blueprints in one or more file formats for processing by the application server. In an embodiment, the application server generates a materials takeoff comprising itemized quantities of building materials derived from analyzed blueprints. In an embodiment, the software application enables scheduling of job tasks and assignment of contractors or workers to specific project segments. In an embodiment, the user computing device is configured to support real-time communication and collaboration between users, suppliers, and contractors. In an embodiment, the application server is configured to store and utilize historical project data to improve accuracy of material estimates and recommendations over time.

### BRIEF DESCRIPTION OF THE ACCOMPANYING DRAWINGS

The novel features which are believed to be characteristic of the present invention, as to its structure, organization, use, and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a schematic representation showcasing a system environment within which different embodiments of the present invention can be implemented and operationalized.

FIG. 2 is a diagram that illustrates a flowchart of a method for managing various functions and operations of the AI-powered software application, in accordance with an embodiment of the present invention.

FIG. 3 is a diagram that illustrates an exemplary flowchart of the operational workflow of the intelligent building application, in accordance with an embodiment of the present invention.

FIG. 4 is a block diagram that illustrates an exemplary interaction among various elements of the system environment, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. Unless stated otherwise, terms such as “first” and “second” are used to arbitrarily distinguish between the elements. Thus, these terms are not necessarily intended to indicate temporal or other prioritization of such elements. While various exemplary embodiments of the disclosed invention have been described below it should be understood that they have been presented for purposes of example only, not limitations. It is not exhaustive and does not limit the invention to the precise form disclosed. Modifications and variations are possible considering the above teachings or may be acquired from practicing of the invention, without departing from the breadth or scope.

Before describing the present invention in detail, it should be observed that the present invention discloses an AI powered software application that leverages cutting-edge AI technology to revolutionize project bidding, resource allocation, and construction assistance. By integrating advanced AI, the application will enable contractors to efficiently track and manage product purchases, alleviating issues like backorders. The application will support users in planning and tracking inventory, connecting with contractors, and utilizing AI to read blueprints for accurate job takeoffs. This will lead to significant reductions in bid times, costs, and inaccuracies that often result in overrun charges. The application will feature multiple functional tabs, including an AI-powered chat for building assistance, a job planner for managing projects and uploading plans, a marketplace for sourcing materials from suppliers, and a cart for tracking material usage per job. Through predictive analytics and real-time AI-driven guidance, the application will optimize resource allocation and ensure the smooth completion of construction projects. This innovative approach will create a collaborative platform, fostering effective communication among developers, contractors, suppliers, and manufacturers, ultimately leading to more efficient and cost-effective project management in the construction industry.

The invention will now be described with reference to the accompanying drawings which should be regarded as merely illustrative without restricting the scope and ambit of the present invention.

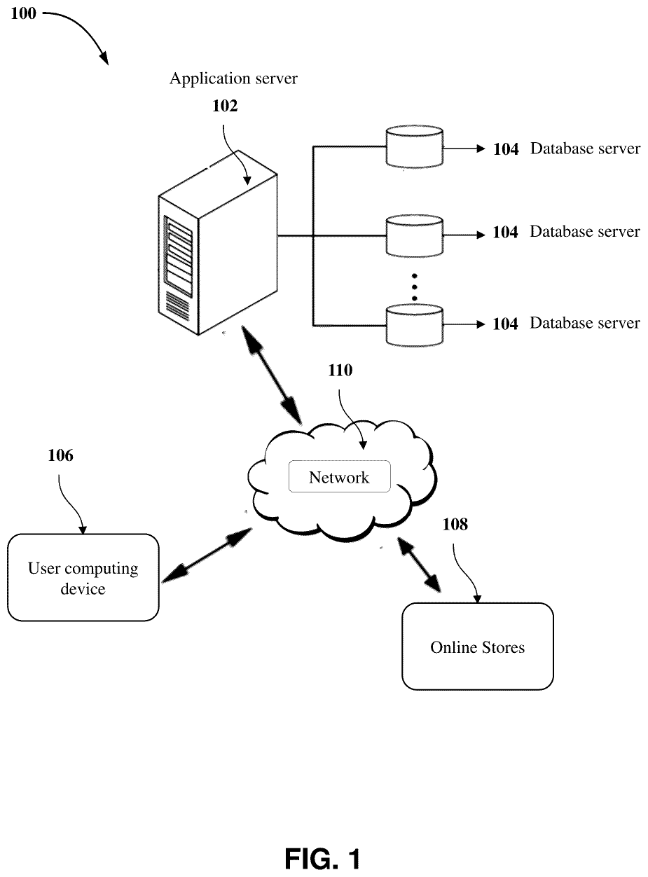

FIG. 1 is a schematic representation, labeled 100, showcasing the system environment within which different embodiments of the present invention can be implemented and operationalized. The system environment 100 includes an application server 102, a database server 104, a user-computing device 106, and one or more online stores 108. There is further shown a communication network 110 via which the application server 102, the database server 104, the user-computing device 106, and the online stores 108 communicate with each other.

The application server 102 serves as the central processing unit of the modular software framework, orchestrating the primary operations and workflows integral to the software application. It is tasked with the execution of the application's logic, interacting with the database server 104 and the online stores 108 to fetch, process, and store data, and catering to requests from the user-computing device 106. In an embodiment, the application server 102 is a critical component in the system environment that hosts and executes the business logic and application processes. It acts as the intermediary between the user-computing device 106 and the database server 104 and the online stores 108, processing user requests, running applications, and managing data interactions. Examples of the application server 102 includes web servers (such as Apache Tomcat, Microsoft Internet Information Services (IIS)), enterprise application servers (such as IBM WebSphere, Oracle WebLogic, JBoss EAP), cloud-based servers (such as Amazon Web Services (AWS) Elastic Beanstalk, Google App Engine, Microsoft Azure App Service), and middleware servers (such as IBM MQ, TIBCO, Oracle Fusion Middleware). The application server 102 may be further configured to communicate with the user-computing device 106 and the database server 104 and the online stores 108 via the communication network 110. This allows seamless data flow and interaction, enabling the system to: serve user requests and provide real-time responses, retrieve and store data efficiently, and maintain secure and reliable communication between system components.

In an embodiment, the application server 102 is the central hub that powers the AI-driven functionalities of the software application. The application server 102 hosts the software application, ensuring that all operations and processes are executed efficiently at the backend. When users interact with the software application, whether it's inputting data, generating materials lists, or querying product information, these requests are sent to the application server 102 for processing. One of the primary functions of the application server 102 is to manage the AI algorithms that drive the application's intelligence. This includes analyzing blueprints to generate accurate job takeoffs, providing real-time product recommendations, and utilizing predictive analytics to forecast project timelines and material requirements. The application server 102 continuously processes and interprets large volumes of data, ensuring that the AI can learn and improve over time, thereby enhancing the accuracy and relevance of its outputs. In addition to AI processing, the application server 102 handles resource allocation and optimization. It coordinates the data flow between different modules of the application, such as the job planner, marketplace, and cart functionalities. For instance, when a user uploads a project plan, the application server 102 processes this information, cross-references it with product databases, and generates a corresponding materials list. It then checks the availability of these materials across various suppliers, ensuring that the information displayed to the user is up-to-date and accurate. The application server 102 also plays a crucial role in managing the marketplace functionality. It interfaces with supplier databases (such as the database 104 or the online stores or marketplaces 108) to retrieve product information, pricing, and availability, which it then integrates into the application's marketplace tab. This allows users to seamlessly browse and purchase materials directly through the application. The application server 102 ensures that the shopping cart feature is synchronized with the marketplace, keeping track of the materials added by the user and their respective sources. Furthermore, the application server 102 facilitates communication and collaboration among various stakeholders, such as contractors, suppliers, and project managers. It manages user authentication, data security, and access control, ensuring that sensitive information is protected while allowing the authorized users to interact and share information within the platform.

The database server 104 is an important component in any software architecture, responsible for storing, retrieving, and managing the data that the application relies on. In general, a database server hosts databases, which are structured collections of data that can be easily accessed, managed, and updated. The database server 104 ensures that data is stored securely, can be efficiently queried, and is available whenever the application needs it. Examples of data stored on a database server might include user information, transaction records, product catalogs, inventory levels, and any other structured data that an application needs to function effectively. In the context of the present invention, the database server 104 plays a vital role in supporting the application's functionality by managing the vast amount of data required for seamless operation. The database server 104 stores all critical data related to the application, including user profiles, project details, blueprint data, materials lists, supplier information, product catalogs, inventory levels, and transaction histories. For instance, when a user inputs a project plan into the application, the data associated with that project, such as the specifications, materials required, and scheduling details, are stored on the database server 104. This allows the application to retrieve and use this data as needed, whether for generating job takeoffs, recommending products, or tracking inventory. The database server 104 also stores data related to AI training models, including historical project data and product information from manufacturers, which the AI uses to improve its recommendations and predictions. Moreover, the database server 104 handles the storage of real-time data, such as current inventory levels from various suppliers. This enables the marketplace function of the application to provide users with accurate, up-to-date information about product availability and pricing. When the users add items to their cart, the database server 104 records these selections and tracks them until the purchase is completed. By ensuring that all data is well-organized, easily accessible, and securely stored, the database server 104 ensures the smooth operation of the software application, allowing it to deliver a powerful, data-driven experience to its users. The server's ability to handle large volumes of data efficiently is essential for the application to provide accurate, timely, and personalized services to contractors, project managers, and other users in the construction industry.

The user computing device 106 is the interface through which the users interact with the intelligent building application. The computing device 106 may be a variety of personal or professional computing hardware, including desktops, laptops, tablets, or smartphones, depending on the user's preferences and needs. The software application is designed to run on these devices, providing the users with a responsive and intuitive platform for managing their construction and repair projects. One of the key features of the user computing device 106 is its role as the primary access point for the application's functionalities. The computing device 106 hosts the user interface (UI) of the software, which is designed to be user-friendly and efficient, allowing the users to navigate through different sections such as the AI-powered chat, job planner, marketplace, and cart with ease. The device's screen size and input methods (e.g., touch, keyboard, or mouse) are taken into consideration to ensure that the application is fully accessible and functional, regardless of whether the user is on a mobile device or a desktop computer.

On the user computing device 106, the users can input project data, view and manage materials lists, communicate with contractors, and browse through supplier offerings. The computing device 106 connects to the application server 102 and the database server 104 over the internet, sending user commands to the backend servers and retrieving processed data, which is then displayed in real-time. This seamless interaction between the device 106 and the servers 102 or 104 ensures that the users have access to up-to-date information and can make informed decisions quickly. Furthermore, the user computing device 106 may also incorporate features such as GPS for location-based services, cameras for scanning and uploading blueprints or project photos, and notification systems to alert users about updates or reminders related to their projects. The device's ability to handle these functions enhances the overall user experience by providing a versatile, multifunctional tool that supports every aspect of project management within the application.

In some embodiments, the user computing device 106 may be configured to manage its security. The computing device 106 may include authentication mechanisms such as passwords, biometrics, or multi-factor authentication to ensure that only authorized users can access the application. This is particularly important for safeguarding sensitive project data, financial information, and personal details stored within the system.

The online stores or marketplaces 108 are integral components of the disclosed system, serving as the digital platforms where the users can browse, compare, and purchase materials and tools required for their construction or repair projects. These online marketplaces are seamlessly integrated into the application, allowing the users to transition smoothly from planning and generating materials lists to purchasing the necessary items. One of the primary features of the online stores or marketplaces 108 is the aggregation of product offerings from multiple suppliers. This enables the users to access a wide variety of products, ranging from raw materials to specialized tools, all in one place. The application pulls real-time data from these online stores, including product availability, pricing, and shipping options, ensuring that the users have the most up-to-date information when making purchasing decisions. This integration reduces the need for the users to visit multiple websites or physical stores, saving them time and effort. In an embodiment, the marketplaces 108 are directly linked to the job planner and materials list features. Once the AI-powered system generates a list of required materials based on the project specifications or blueprint analysis, this list is automatically populated within the marketplace section. The users can then see which suppliers offer the needed materials, compare prices, and make purchases with just a few clicks. This level of integration ensures that the purchasing process is efficient, accurate, and aligned with the project's needs. Additionally, the online stores or marketplaces 108 offer customization and filtering options, allowing the users to search for products based on specific criteria such as brand, price range, delivery time, or supplier location. This helps the users to find the best deals and ensure that the materials meet their project's requirements. Some marketplaces may also offer user reviews, product ratings, and detailed descriptions, further aiding in the decision-making process. The marketplaces 108 also support a cart functionality, where the users can add items from different suppliers, review their selections, and proceed to checkout. This cart is synced with the overall project management system within the application, allowing the users to track their purchases and material usage per job. The application also facilitates payment processing, either directly through the integrated online stores or by redirecting the users to the supplier's secure payment gateway.

The communication network 110 enables seamless connectivity and data exchange between the application server 102, the database server 104, the user computing device 106, and the online stores 108. This network 110 ensures that all components of the disclosed system can communicate efficiently, facilitating real-time data transfer, processing, and interaction. The communication network 110 can comprise both wired and wireless network technologies, each playing a crucial role in maintaining robust and reliable connections within the system.

The operation of the disclosed system and methods is centered around delivering a seamless, AI-powered experience that enhances the efficiency and accuracy of managing construction and repair projects. This is achieved through the interaction between the user, the application running on their computing device 106, and the backend infrastructure, which includes the application server 102 and the database server 104. The integration with online stores or marketplaces 108 further streamlines the purchasing of materials, making the entire process intuitive and efficient.

In an embodiment, when a user begins using the software application on their computing device 106, the user is first provided with a user-friendly interface featuring four primary tabs at the bottom of the screen: AI chat, Job planner, Marketplace, and Cart. Each of these tabs offers distinct functionality that collectively supports the entire project management process.

In an embodiment, the AI chat is the first tab and serves as an intelligent assistant within the application. When a user inputs a query or command, such as asking for recommendations on materials based on a specific project or blueprint, this request is sent to the application server 102. The server 102 processes the request using advanced AI algorithms and accesses relevant data from the database server 104. The AI chat then responds with accurate and context-sensitive suggestions, whether it's identifying the correct materials, estimating quantities, or providing links to supplier products. This feature is particularly useful for both novices and experienced professionals, as it helps in decision-making by leveraging AI's ability to analyze large amounts of data quickly.

In an embodiment, the second tab is the Job planner, where the users can organize and manage their projects. Here, the users can create new jobs, input schedules, assign tasks to contractors, and upload blueprints for detailed analysis. The blueprint analysis is handled by the application server 102, which uses AI to generate a comprehensive materials list based on the project's specifications. This information is stored in the database server 104, ensuring that it can be retrieved and updated as the project progresses. The Job planner also allows the users to track the progress of their projects, manage timelines, and ensure that all necessary materials are accounted for before the project moves forward.

In an embodiment, the Marketplace is the third tab, which integrates directly with the materials lists generated in the Job planner. Once a materials list is created, the user can switch to the Marketplace tab, where the application will display available products from various online stores or marketplaces 108. The application server 102 communicates with these external sources in real-time, pulling in data such as product availability, pricing, and supplier details. The users can compare options, read reviews, and select the best products to purchase. This feature eliminates the need for the users to visit multiple websites, providing a one-stop solution for sourcing all required materials.

In an embodiment, the final tab is the Cart, which functions as a centralized repository for all the items selected by the user from the Marketplace. As the users add products to their cart, the application updates the cart in real-time, tracking the items selected from different suppliers. This tab allows the users to review their selections, adjust, and proceed to checkout. The application server 102 ensures that all transactions are securely processed, and the database server 104 keeps a record of the purchases, linking them to the specific job for which the materials were intended. Additionally, the Cart tab enables the users to monitor their material usage and expenditures across various projects, providing a clear overview of resource allocation.

Throughout the entire process, the application server 102 orchestrates the backend operations, ensuring that all user requests are processed accurately and efficiently. Whether it's retrieving data from the database server 104, generating AI-driven insights, or interacting with external marketplaces 110, the application server 102 is responsible for maintaining the seamless flow of information between the user's device and the underlying infrastructure. This ensures that the users receive real-time feedback and updates, enabling them to make informed decisions quickly.

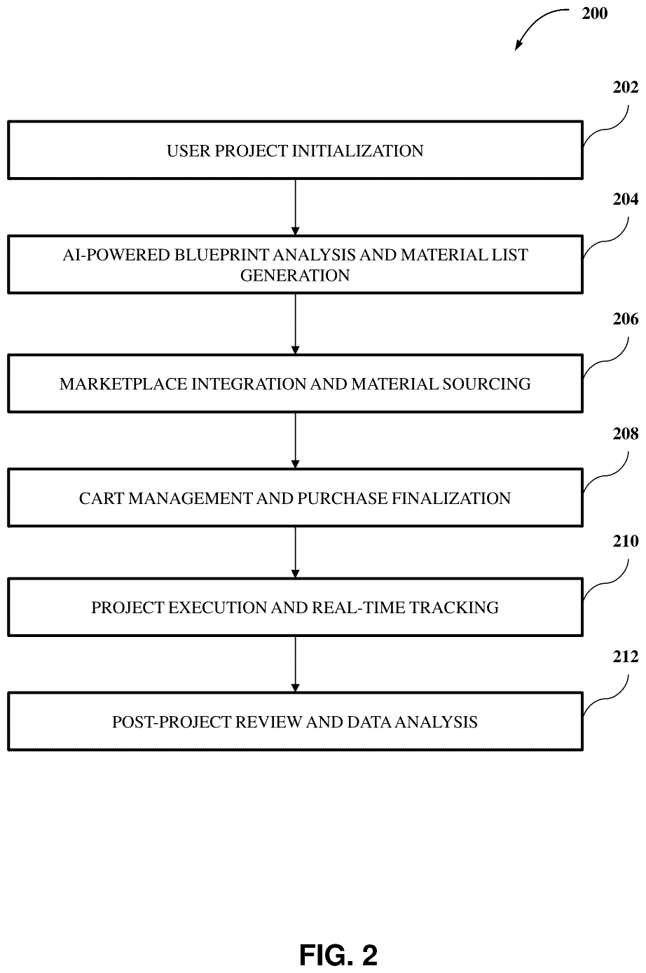

FIG. 2 is a diagram that illustrates a flowchart 200 of a method for managing various functions and operations of the AI-powered software application, in accordance with an embodiment of the present invention.

At step 202, the user project initialization is performed. In an embodiment, the process begins when a user opens the application on their computing device 106 and initializes a new project through the Job planner tab. The user inputs essential project details, such as the project name, timeline, and scope of work. The user can also upload blueprints or other relevant documents. The application server 102 receives this data and stores it securely on the database server 104, ensuring that the project is well-documented and can be accessed or modified as needed. This step lays the foundation for all subsequent actions, organizing the project's basic parameters

At step 204, the AI-powered blueprint analysis and material list generation are performed. In an embodiment, once the project is set up, the user can utilize the AI chat or Job planner to analyze the uploaded blueprints or input specific project requirements. The AI component, hosted on the application server 102, processes the blueprint or user input to generate a detailed materials list. This includes identifying the types and quantities of materials needed based on the project's specifications. The AI uses data stored on the database server 104, such as historical project data, product information, and construction standards, to ensure accuracy. This step is crucial as it automates the traditionally time-consuming process of materials estimation, significantly reducing the potential for human error.

At step 206, the marketplace integration and material sourcing are performed. In an embodiment, after the materials list is generated, the user navigates to the Marketplace tab to source the necessary items. The application server 102 connects with various online stores or marketplaces 110, retrieving real-time data on product availability, pricing, and supplier details. The materials list from the previous step is cross-referenced with the marketplace offerings, allowing the user to browse through different options and select the best products for their project. This integration ensures that the users have access to a wide range of suppliers and can make informed purchasing decisions without leaving the application.

At step 208, the cart management and purchase finalization are performed. In an embodiment, as the user selects materials in the Marketplace, these items are added to the Cart tab. The Cart functions as a centralized space where the user can review all selected materials, ensuring that nothing is overlooked before finalizing the purchase. The application server 102 keeps the Cart updated in real-time, reflecting any changes the user makes. When the user is ready to proceed, they can finalize the purchase directly through the application. The server 102 ensures that the transaction is securely processed, and the database server 104 records the purchase details, linking them to the specific project for future reference and tracking.

At step 210, the project execution and real-time tracking are performed. In an embodiment, with the materials sourced and purchased, the user can begin executing the project. The Job planner tab continues to play a vital role during this stage, helping the user track the progress of the project, manage tasks, and monitor the delivery of materials. The application server 102 provides real-time updates, allowing the users to adjust schedules, reorder materials if necessary, and communicate with contractors. The AI may also offer insights or recommendations based on the project's status, helping to optimize resource allocation and ensure that the project stays on track.

At step 212, after the project is completed, the user can review the entire process through the application. The data stored on the database server 104, including materials usage, costs, timelines, and any AI-generated insights, can be analyzed to evaluate the project's efficiency and outcomes. This step allows the users to learn from each project, identifying areas for improvement in future endeavors. The AI component can also use this data to refine its algorithms, becoming more accurate and effective in subsequent projects. This continuous learning loop enhances the overall utility of the application, making it an increasingly valuable tool over time.

The invention described is a sophisticated application that leverages AI to revolutionize project management in the construction and repair industries. By implementing this software application, the contractors and project managers can achieve unprecedented levels of efficiency and accuracy in tracking and managing products purchased for specific jobs. One of the primary benefits of this application is its ability to alleviate backorders, a common issue that can cause significant delays and increased costs in construction projects. The application provides the users with tools to input their schedules, connect with contractors, and track inventory in real-time, ensuring that all necessary materials are available when needed and that project timelines are adhered to. A central feature of the disclosed application is its use of cutting-edge AI technology to analyze product data and generate accurate job takeoffs. Job takeoffs, which involve estimating the quantities and types of materials required for a project, are traditionally time-consuming and prone to errors. However, by utilizing AI, the application can quickly and accurately interpret blueprints and other project inputs to produce precise materials lists. This automation not only reduces the time needed for bidding on projects but also minimizes the risk of inaccurate product callouts, which can lead to costly overruns and delays further down the line. The application serves multiple key functions, including project bidding, resource allocation, and building assistance, all enhanced by AI. The AI is trained in construction-specific language and product data, enabling it to understand and interpret complex blueprints and provide relevant insights. The application is developed on a current AI platform, ensuring that it is both scalable and adaptable to future advancements in AI technology. By training the AI using manufacturers' product data, the application can offer highly accurate and context-specific recommendations, making it an invaluable tool for contractors and project managers.

One of the critical aspects of the application is its ability to partner with suppliers to integrate their products directly into the platform. This collaboration ensures that the users can access a wide range of materials and products directly within the application, streamlining the procurement process. The application's interface is designed with complete aesthetics in mind, ensuring that it is not only functional but also user-friendly and visually appealing, enhancing the overall user experience. The AI-powered purchasing feature is another standout component of the application. By utilizing machine learning algorithms, the system can generate product recommendations based on user queries or blueprint data. This feature is particularly useful during the planning and bidding stages of a project, as it ensures that the users are presented with the most relevant and cost-effective materials options. Additionally, the system incorporates predictive analytics to analyze historical project data and external factors, enabling it to forecast project deliveries, manage scheduling, and prevent backorders. This predictive capability is essential for maintaining project timelines and avoiding costly delays. Resource optimization is another vital function of the application. Through advanced optimization techniques, the system ensures that resources, whether materials, labor, or time, are allocated efficiently. The AI-driven recommendations provided by the system help the users select the best supplier options and product specifications to meet their project needs. This not only reduces waste but also ensures that projects are completed on time and within budget.

The application also offers real-time assistance to the users throughout the project lifecycle. By continuously analyzing product data with AI, the system guides the users from project initiation to completion, identifying the materials needed, the required quantities, and the best suppliers for each item. This real-time guidance helps the users make informed decisions at every stage of the project, reducing the likelihood of errors and ensuring that the project progresses smoothly. Finally, the application serves as a collaborative platform, facilitating communication and coordination among various stakeholders, including developers, contractors, suppliers, and manufacturers. This centralized platform ensures that all parties are aligned and have access to the same information, promoting transparency and efficiency. The ability to share data and updates in real-time helps to prevent misunderstandings and delays, ultimately leading to more successful project outcomes.

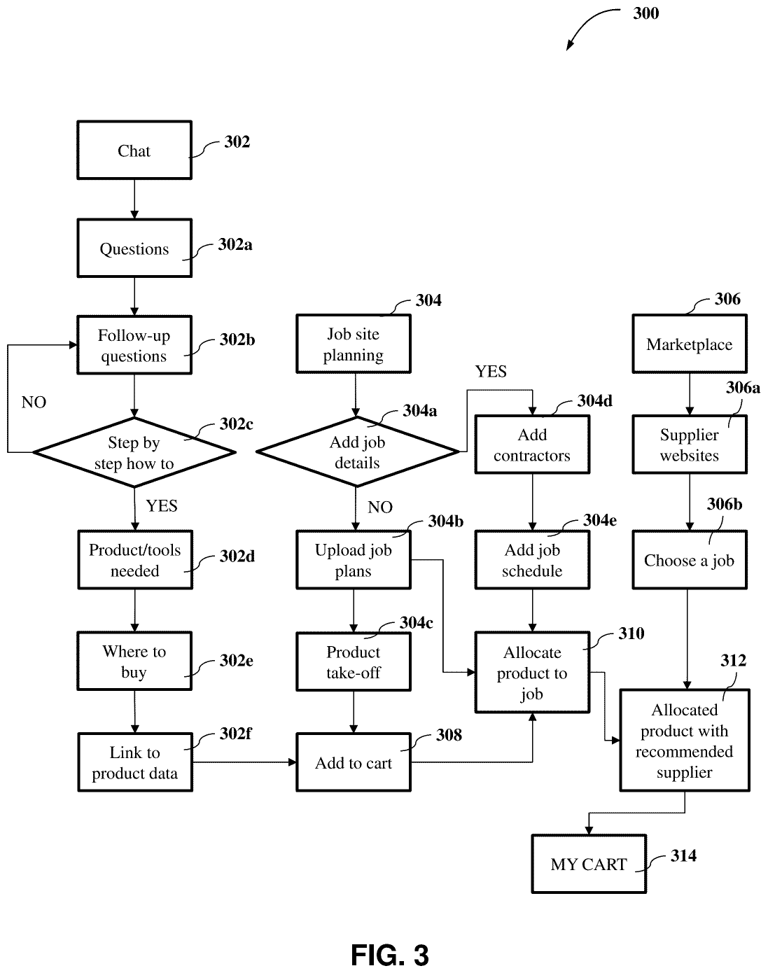

FIG. 3 is a diagram that illustrates an exemplary flowchart of the operational workflow of the intelligent building application, in accordance with an embodiment of the present invention.

At step 302, the user initiates the process through the AI-powered Chat interface, which acts as an intelligent assistant. This interface allows the users to type natural language queries or select predefined options to begin the planning or support process. The chat serves as the entry point for AI interaction and project guidance. Following the initial chat, at step 302a, the AI prompts the user with follow-up questions to better understand the project context. These questions may include prompts like “What type of project are you working on?”, “Where is the job site located?”, or “Do you have existing blueprints?” The goal is to gather sufficient input to personalize the workflow and anticipate the user's material, scheduling, and regulatory needs. At 302b, this step continues the AI interaction by capturing detailed user responses, either about construction challenges, planning queries, or tool/material inquiries. The AI uses these responses to refine its understanding and trigger downstream actions such as generating a materials list or suggesting compliance-based product matches.

At step 302c, based on the previous responses, the AI may present a step-by-step guide on how to proceed. This could range from how to begin excavation for a foundation to how to safely install a certain type of window. This step ensures that the user receives procedural guidance before being directed to material or job planning tools.

Once a task is identified, at step 302d, the AI engine determines what products or tools are needed for execution. For example, if the task involves drywall installation, the system will list specific drywall sheets, joint compound, fasteners, and taping tools, pulling from a product knowledge database.

At step 302e, the application next identifies where these products or tools can be purchased, leveraging the real-time integration with the connected supplier databases and online marketplaces. This eliminates the need for users to manually search across multiple sites.

At step 302f, the system provides direct links to product data, including product specifications, certifications (e.g., ISO, ASTM), pricing, and availability. The users can compare alternatives and ensure that the chosen product meets the required standards or job specifications.

At step 304, the user proceeds to plan the job site within the application. This includes defining key tasks, assigning roles, and laying out the job phases. This planning stage creates a foundation upon which other modules like scheduling, material takeoff, and procurement are built.

At step 304a, the user adds specific job details, such as the project type (e.g., residential, commercial), square footage, location, code constraints, and other metadata that will influence product selection and AI guidance.

At step 304b, the system then prompts the user to upload blueprints or construction drawings, which the AI analyzes to generate a materials list. The AI uses computer vision and NLP-based blueprint parsing to understand the components, quantities, and stages of construction.

At step 304c, using the uploaded job plans, the AI generates a product takeoff, identifying the exact quantities and types of materials required for execution. This list is built with reference to best practices and localized construction norms.

At step 304d, the user can add contractors to the job, assigning them to specific roles or stages of the project. The application supports contractor scheduling and task allocation to ensure the project moves according to plan. The step 304e involves the creation of a detailed project schedule, broken into phases (e.g., excavation, foundation, framing, finishing). The schedule is linked to material availability and contractor timelines to facilitate predictive analytics and reduce delays.

At step 306, the user is directed to the marketplace tab, which aggregates supplier product listings. This view displays real-time inventory, prices, and delivery options for the products listed in the takeoff.

At step 306a, the system references external supplier websites or APIs to collect real-time data, enabling the marketplace to offer accurate recommendations and avoid procurement bottlenecks due to stockouts or backorders.

At step 306c, the users with multiple projects in progress can select the specific job they wish to view or update. This contextual switch ensures that the right project data, takeoffs, and purchase plans are active.

At step 308, the selected and allocated products are added to the user's cart. The system may automatically group items by supplier to simplify the ordering process and reduce shipping complexity.

At step 310, after reviewing options, the users can allocate specific products to particular job tasks or milestones. This allows for better tracking and planning at the task level and links each item to both its function and its stage in the schedule.

At step 312, once the product is allocated, the system finalizes the supplier recommendation, linking each allocated material with the most optimal vendor based on delivery lead time, cost, or certification compliance.

At step 314, the “My Cart” module is shown, which may have a consolidated view of all materials selected for the active job. The cart enables the users to review purchases, compare suppliers, and initiate secure transactions. It also serves as a tracking hub for delivery timelines and order confirmations.

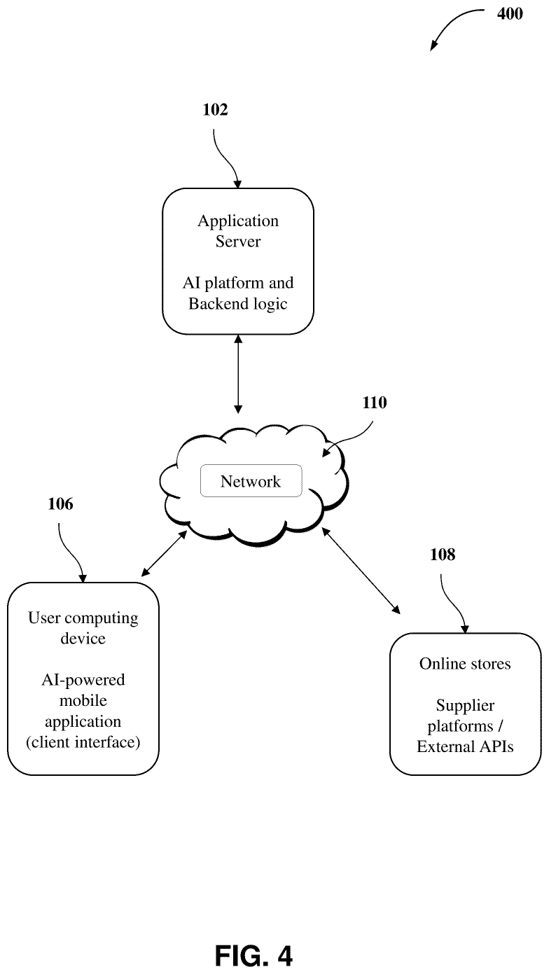

FIG. 4 is a block diagram 400 that illustrates an exemplary interaction among various elements of the system environment 100, in accordance with an embodiment of the present invention. As shown, the present invention presents the comprehensive, AI-powered platform for construction and repair project management. Each component plays a critical role in enabling automated planning, intelligent material sourcing, dynamic purchasing, and collaborative decision-making. The system architecture 400 comprises essential components such as the application server 102 hosting the AI platform and the software application, the user computing device 106, and the external online stores or marketplaces 108. The AI application refers to the deployed software component of the intelligent building platform that interfaces directly with the end users. It is implemented using mobile-compatible frameworks and web technologies that allow seamless cross-device operability. The AI application executes client-side rendering, initiates server requests, and receives and visualizes intelligent feedback from the AI backend. The AI platform is the server-side intelligence infrastructure. It consists of a proprietary large language model trained on domain-specific corpora, including construction specifications, supplier catalogs, regulatory documents, safety standards, and common job site scenarios. It is further enhanced by reinforcement learning and supervised fine-tuning from construction engineers and procurement specialists. The AI platform operates through a series of interconnected models and services: (1) Natural Language Understanding (NLU) engine to parse queries like “What's the best waterproofing membrane for a basement in a flood zone?” (2) Document ingestion pipeline to extract product metadata from supplier catalogs and regulatory PDFs. (3) Inference engine that combines learned models with rule-based systems to generate structured outputs (materials lists, step-by-step instructions, certifications needed). (4) Conversational interface manager that supports human-like dialog flow, allowing users to clarify, drill down, or revise their requests iteratively. By integrating all of the above, the platform acts not only as a planning and procurement engine but also as a collaborative AI assistant that supports project managers across the entire construction lifecycle: from estimation to execution and post-project review.

The application server 102 functions as the backend processing engine and logic core of the intelligent building platform. The application server 102 is configured to host the AI software application and all AI-based reasoning, inference, and decision-making functionalities. The application server 102 interfaces with the user computing device 106, database servers 104, and the external data sources (such as supplier APIs), executing business logic and responding to requests in real-time. At the core of the application server 102 is the AI platform, which is powered by a construction-specific large language model (LLM) and tailored machine learning models. This AI platform understands the language of construction and regulatory compliance, allowing it to parse blueprints, interpret natural language queries, and correlate product data with applicable standards and job-specific parameters. Key functional modules of the application server 102 include: (1) AI-powered planning and estimation engine: On receiving project parameters (e.g., “Build a 1000 sq ft two-story home in Texas”), the server 102 analyzes architectural requirements, identifies necessary materials, estimates quantities, highlights potential regulatory constraints (e.g., Texas fire codes or insulation R-values), and generates a materials list with associated cost estimates. This data is then presented to the user computing device 106 via a dynamic user interface. (2) AI-powered troubleshooting module: If a problem arises during a construction task (e.g., improper alignment of steel reinforcement bars), the user may ask the AI assistant. The AI module uses pre-trained knowledge and real-time user data to suggest solutions, such as rework procedures, design tolerances, or applicable standards like ACI or ASTM fixes. (3) Product sourcing and compliance engine: This sub-module queries databases of supplier-certified products and matches material requirements with products that meet ISO, ASTM, or local building code certifications. For instance, if a user requires fire-rated drywall that complies with ASTM E119, the system cross-references multiple supplier inventories and returns compliant options. (4) Marketplace integration layer: This layer facilitates API-based communication with third-party online marketplaces 108. It fetches real-time supplier data including inventory, pricing, delivery timelines, and product specifications. The AI engine automatically suggests the most optimal purchase sources based on availability, distance, regulatory compliance, and historical supplier reliability. (5) Predictive analytics module: This module analyzes historical project data and external variables (weather, shipping patterns, supplier lead times) to forecast delays and material backorders. For instance, if insulation material from a preferred vendor is often delayed in winter months, the system may preemptively recommend alternate suppliers or early ordering. (6) Optimization engine: Using linear programming or reinforcement learning models, the application server 102 suggests optimal supplier-product combinations that minimize cost and maximize schedule adherence while meeting quality constraints.

The application server 102 is further configured to perform secure authentication, user role management, real-time data caching, and periodic model retraining to ensure accuracy and responsiveness.

The user computing device 106 may be configured to execute the client-side instance of the AI-powered mobile or web application and serves as the primary user interface through which contractors, developers, or project managers interact with the system. The application displayed on the user computing device 106 comprises multiple functional user interfaces, including but not limited to: (i) an AI-driven chat assistant, (ii) a job planner interface, (iii) a marketplace interface, and (iv) a cart module. Upon initializing the application on the user computing device 106, the user may input project parameters, such as project size, location, scope of work, budget constraints, or upload architectural blueprints. For example, a user planning to construct a 5,000 sq. ft. residential building in a coastal zone may input structural preferences, regulatory constraints, and desired timelines. The data is transmitted via the application to the backend application server 102 for processing. The user computing device 106 may also include a camera, GPS, and real-time communication capabilities to capture onsite data (e.g., progress photos, barcode scans) and allow for intelligent feedback and troubleshooting during construction phases.

The online marketplaces 108 represent external, third-party supplier platforms connected to the application server 102 via secure APIs or data feeds. These marketplaces 108 offer access to diverse material inventories, including but not limited to building materials, tools, equipment, and regulatory-certified products. In operation, after the application server 102 generates a materials list, it dispatches structured queries to the online marketplaces 108. For instance, if the AI determines that 400 sq. ft. of Class A fire-rated roof shingles are required, it queries connected marketplaces for relevant products, filtering based on pricing, availability, and proximity to the project site. Marketplace responses are parsed and displayed within the user interface on the user computing device 106 under the “Marketplace” tab. The users can then review, compare, and add items directly to their in-application cart for procurement. The marketplaces may also provide product certifications, user ratings, bulk discounts, or supplier reliability scores, which are processed by the AI for refined recommendation logic.

The proposed AI-powered platform and application offers a wide range of advantages and applications across the construction and repair industries. By integrating artificial intelligence with real-time data processing and marketplace connectivity, it significantly streamlines project planning, estimation, sourcing, and execution. Key advantages include automated and highly accurate material takeoffs from blueprints, reduced bid preparation time, elimination of manual errors, and minimized project overruns. The system's predictive analytics help in anticipating material delivery delays and backorders, while its AI-powered recommendations ensure that only code-compliant and specification-matching products are procured. Users benefit from centralized job planning, contractor coordination, scheduling, and collaborative communication, all from a single interface. Applications span across residential, commercial, and infrastructure projects, including new builds, renovations, and repair works. It is especially valuable for general contractors, subcontractors, project managers, architects, and procurement teams seeking to improve efficiency, reduce costs, and ensure compliance with local and industry standards. Additionally, the application's ability to provide step-by-step troubleshooting and dynamically adapt to on-site issues makes it a powerful real-time assistant on active job sites. Further, the present invention should not be construed as abstract because it is directed to a practical, concrete, and technologically implemented solution that improves the construction project workflow by integrating AI-driven features with real-world data sources and physical operations. The claimed system is not merely a generic idea of organizing or processing information, but rather a specific and structured technological architecture comprising a user computing device, an application server hosting a construction-trained AI platform, integration with online marketplaces, and a database of structured material and supplier data. It performs tangible functions, such as blueprint interpretation for generating materials takeoffs, sourcing compliant products from real suppliers, managing job schedules and contractor assignments, and tracking physical inventory across project phases. These functionalities are deeply rooted in hardware-software interactions and result in real-world effects like reduced delays, accurate procurement, and optimized jobsite performance. Thus, the invention applies advanced computing to solve a long-standing, domain-specific problem, making it patent-eligible subject matter.

The disclosed invention pertains to a system for managing construction and repair projects using artificial intelligence (AI) integrated into a unified software platform. The core of the system includes three primary components: an application server, a user computing device, and a software application hosted on the server and executed on the user device. The application server is configured to host a software application that incorporates an AI platform specifically trained on construction-related domains. The AI platform has been trained using datasets related to construction-specific language, blueprint interpretation, and product specification data. This training enables the system to intelligently interpret complex construction inputs and provide meaningful outputs that improve the efficiency and accuracy of project planning and execution. The users interact with the system via a user computing device, which may include a mobile device running a dedicated mobile application. This application presents a user interface comprising multiple tabs, including chat, job planning, marketplace browsing, and material tracking. The users can upload various types of project-related data through this interface, such as free-form inputs, job parameters, construction schedules, and importantly, digital blueprints or job plans. The system supports a variety of file formats for case of integration into real-world workflows. Upon receiving the project data, the application server, via the AI platform, analyzes the input, particularly blueprints, to determine the exact materials required for the construction or repair job. This process includes generating a detailed materials takeoff, which is an itemized list of building materials needed based on the structure or requirements described in the blueprint. In addition to generating the materials list, the AI platform performs intelligent product recommendations. These recommendations are made not only based on availability but also on compatibility with project specifications, as well as compliance with relevant construction codes and standards such as ISO, ASTM, or local regulations. The system can dynamically update the recommendations when there is any change in the input data, ensuring real-time adaptability throughout the project lifecycle. To further assist the user, the AI system can generate step-by-step task instructions corresponding to the input data and anticipated project phases. This feature aids professionals and field personnel by guiding them through construction tasks and troubleshooting. The marketplace module of the software application interfaces with multiple online suppliers and marketplaces, pulling in real-time data on pricing, product availability, delivery timelines, and product certifications. This data is then displayed within the application interface, allowing users to compare suppliers and source materials efficiently. The system supports product allocation to specific job phases, ensuring granular visibility into material flow and usage. The selected materials are added to a cart module, which supports tracking by supplier, cost, quantity, and schedule. The user can review and finalize purchases within this cart interface. Additionally, the system leverages predictive analytics to forecast material backorders, supplier shortages, or delivery delays, allowing users to mitigate procurement risks early. The invention further supports job scheduling, including task assignments to contractors and workers. It also allows for real-time communication and collaboration among users, contractors, and suppliers, improving transparency and responsiveness throughout the project lifecycle. Further, the application server is designed to store and utilize historical project data. This data informs future AI predictions and product recommendations, continually improving the platform's intelligence and utility over time.

Based on at least the above, the disclosed invention should not be construed as abstract because it is directed to a technological solution to a technological problem and is rooted in real-world, physical operations. It is not a mere idea of organizing information or performing mental steps, but rather a practical implementation of a complex AI-powered system that interacts with physical construction activities, supplier systems, and real-time project data. The claimed system employs specific hardware components (user device, application server), specialized AI training and analysis techniques, and structured interactions with external data sources and marketplaces to generate tangible results such as material procurement, blueprint-based takeoffs, and predictive forecasts of construction logistics. Moreover, the invention is not merely a result of generic computing, but a purposeful integration of AI with construction-specific datasets, resulting in enhanced procurement workflows, jobsite coordination, and regulatory compliance management. It enables actionable outcomes such as material sourcing from real suppliers, tracking of physical deliveries, allocation of resources to job phases, and step-by-step task execution. These operations have practical applications and measurable effects in the field of construction and repair, far beyond abstract data manipulation. The invention also includes specific structural arrangements and functional modules, such as AI-powered chat, dynamic blueprint parsing, real-time supplier interface, and cart tracking, executed over computing infrastructure. The combination of these technical features demonstrates that the invention is technologically grounded and should be recognized as a patent-eligible, non-abstract solution to challenges inherent in construction project management.

The foregoing descriptions of specific embodiments of the present technology have been presented for purposes of illustration and description. They are not intended to be exhaustive or to limit the present technology to the precise forms disclosed, and obviously many modifications and variations are possible considering the above teaching. The embodiments were chosen and described to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A system for managing construction and repair projects utilizing artificial intelligence, the system comprising:
an application server configured to host a software application incorporating an artificial intelligence platform; and
a user computing device configured to execute the software application and transmit project-related data to the application server,
wherein the application server is configured to analyze the project-related data to generate a list of required materials and associated product information; and
wherein the software application is further configured to enable procurement of one or more of the materials from one or more online marketplaces based on the generated list, such that the system facilitates intelligent material planning and purchasing from within a unified application environment.

2. The system of claim 1, wherein the artificial intelligence platform is trained on construction-specific language, blueprint interpretation, and product specification data.

3. The system of claim 1, wherein the project-related data includes user-entered inputs, uploaded blueprints, schedules, and construction requirements.

4. The system of claim 1, wherein the artificial intelligence platform analyzes one or more blueprints to identify materials required for the project.

5. The system of claim 1, wherein the application server is configured to recommend one or more products based on availability, compatibility with project specifications, and compliance with applicable construction standards.

6. The system of claim 1, wherein the application server is further configured to generate step-by-step task instructions based on the project-related data.

7. The system of claim 1, wherein the user computing device includes a mobile application providing a user interface with tabs for chat, job planning, marketplace browsing, and material tracking.

8. The system of claim 1, wherein the software application includes an AI-powered chat interface configured to receive user queries and respond with project guidance or product suggestions.

9. The system of claim 1, wherein the software application includes a marketplace interface that displays real-time data from multiple suppliers or online marketplaces.

10. The system of claim 1, wherein the application server retrieves supplier data including product availability, pricing, delivery times, and certifications.

11. The system of claim 1, wherein the system allocates products to specific jobs or job phases based on the user's project plan.

12. The system of claim 1, wherein the system includes a cart interface that enables users to track selected materials by supplier, quantity, cost, and delivery schedule.

13. The system of claim 1, wherein the artificial intelligence platform uses predictive analytics to forecast delivery delays, supplier shortages, or material backorders.

14. The system of claim 1, wherein the system is configured to cross-reference product data against one or more compliance standards.

15. The system of claim 1, wherein the application server dynamically updates material recommendations based on modifications to the project-related data.

16. The system of claim 1, wherein the user computing device is configured to allow uploading of job plans or blueprints in one or more file formats for processing by the application server.

17. The system of claim 1, wherein the application server generates a materials takeoff comprising itemized quantities of building materials derived from analyzed blueprints.

18. The system of claim 1, wherein the software application enables scheduling of job tasks and assignment of contractors or workers to specific project segments.

19. The system of claim 1, wherein the user computing device is configured to support real-time communication and collaboration between users, suppliers, and contractors.

20. The system of claim 1, wherein the application server is configured to store and utilize historical project data to improve accuracy of material estimates and recommendations over time.
